(19) United States
(12) Patent Application Publication
(10) Pub. No.: US 2025/0007198 A1
(43) Pub. Date: Jan. 2, 2025

(54) PROTECTION DEVICES FOR ELECTRICAL CONNECTION ASSEMBLIES AND RELATED ELECTRICAL CONNECTION ASSEMBLIES

(71) Applicant: TE Connectivity Solutions GmbH, Schaffhausen (CH)

(72) Inventors: Austin Draughn, Garner, NC (US); George Pullium, III, Garner, NC (US); Kathryn Marie Maher, Cary, NC (US)

(21) Appl. No.: 18/627,948

(22) Filed: Apr. 5, 2024

Related U.S. Application Data
(60) Provisional application No. 63/510,995, filed on Jun. 29, 2023.

(51) Int. Cl. H01R 13/50; H01R 13/512; H01R 13/516; H01R 13/52; H01R 13/66

(52) U.S. Cl. CPC H01R 13/501; H01R 13/512; H01R 13/516; H01R 13/5208; H01R 13/6683

(57) ABSTRACT

The present disclosure describes protection devices for electrical connection assemblies. A protection device includes a first housing member having a main body having a length, the first housing member having a main channel, a first and second cable channel that together extend longitudinally the length of the main body, and an identical second housing member configured to be mated and secured to the first housing member via one or more locking mechanisms configured to be received by or engaged with one or more corresponding apertures and/or recesses. When the first and second housing members are mated together, the aligned main channels of the first and second housing members form an internal cavity configured to hold an electrical component therein and the aligned first and second cable channels are configured to hold respective cables connected to the electrical component therein. Other protection devices and related electrical connection assemblies are described herein.

### RELATED APPLICATION(S)

The present application claims priority to and the benefit of U.S. Provisional Patent Application Ser. No. 63/510,995, filed Jun. 29, 2023, the disclosures of which are hereby incorporated by reference in their entirety.

### FIELD

The present invention relates to electrical connections and, more particularly, to protection devices for electrical connection assemblies.

### BACKGROUND

Currently, many in-line electrical components in an electrical connection assembly utilize one or more layers of overmold to seal and protect the electrical component from, for example, environmental conditions. However, existing overmolded electrical connection assemblies can be expensive or difficult to produce because of the complexity of the molding process involved. Therefore, alternative ways to seal and protect the in-line electrical components in an electrical connection assembly may be desired.

### SUMMARY

Embodiments of the present invention are directed to a protection device for an electrical connection. The protection device includes a first housing member having a main body having a length, the first housing member having a main channel, a first cable channel, and a second cable channel that together extend longitudinally the length of the main body, and a substantially identical second housing member configured to be mated and secured to the first housing member via one or more locking mechanisms configured to be received by or engaged with one or more corresponding apertures and/or recesses. When the first housing member and the second housing member are mated together, the aligned main channels of the first and second housing members form an internal cavity sized and configured to hold an electrical component therein and the aligned first and second cable channels are sized and configured to hold respective cables connected to the electrical component therein.

Further embodiments of the present invention are directed to an electrical connection assembly. The electrical connection assembly includes an in-line electrical component having a pair of cables connected to and extending outwardly from opposing ends of the electrical component and a protection device surrounding the in-line electrical component and creating a seal with the pair of cables. The protection device includes a first housing member having a main body having a length, the first housing member having a main channel, a first cable channel, and a second cable channel that together extend longitudinally the length of the main body, and an identical second housing member configured to be mated and secured to the first housing member via one or more locking mechanisms configured to be received by or engaged with one or more corresponding apertures and/or recesses. The first housing member and the second housing member are mated together such that the electrical component is held within the aligned main channels of the first and second housing members and each cable is respectively held within the aligned first and second cable channels.

Further embodiments of the present invention are directed to a protection device for an electrical connection. The protection device includes a tubular housing having a main body including threaded sections at opposing ends of the main body and a bore extending therethrough; a pair of grommets, each grommet having an annular main body with an opening extending therethrough, the opening being sized and configured to receive a cable connected to an electrical component; a pair of pinch rings, each pinch ring having an annular main body with an opening extending therethrough that is sized and configured to receive a respective grommet, each pinch ring being integral with or coupled to a respective threaded sections of the housing; and a pair of securing members, each securing member having a main body with at least a portion of an inner surface of the main body having a threaded section configured to engage a respective threaded section of the housing. The bore of the housing is sized and configured to hold the electrical component therein and the pinch rings and grommets are configured to create a seal between the protection device and the cables connected to the electrical component.

Further embodiments of the present invention are directed to an electrical connection assembly. The assembly includes an in-line electrical component having a pair of cables connected to and extending outwardly from opposing ends of the electrical component and a protection device surrounding the in-line electrical component and creating a seal with the pair of cables. The protection device includes a tubular housing having a main body including threaded sections at opposing ends of the main body and a bore extending therethrough; a pair of grommets, each grommet having an annular main body with an opening extending therethrough, the opening being sized and configured to receive a cable connected to an electrical component; a pair of pinch rings, each pinch ring having an annular main body with an opening extending therethrough that is sized and configured to receive a respective grommet, each pinch ring being integral with or coupled to a respective threaded sections of the housing; and a pair of securing members, each securing member having a main body with at least a portion of an inner surface of the main body having a threaded section configured to engage a respective threaded section of the housing. The electrical component is contained within the bore of the housing and the pinch rings and grommets create a seal between the protection device and the cables connected to the electrical component.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a perspective view of an electrical connection assembly according to embodiments of the present invention.

FIG. 2A is a perspective view of the assembly of FIG. 1 with a first housing member of the protection device removed to show a heat shrink layer applied to an electrical component of the electrical connection assembly according to embodiments of the present invention.

FIG. 2B is a perspective view of the electrical connection assembly of FIG. 2A without the heat shrink layer applied to the electrical component (e.g., a photovoltaic fuse) of the electrical connection assembly according to embodiments of the present invention.

FIG. 3A is a perspective view of a protection device for the electrical connection assembly of FIG. 1 according to embodiments of the present invention.

FIG. 3B is an exploded side view of the protection device of FIG. 3A.

FIG. 4 is a perspective view of a housing member of the protection device of FIGS. 3A-3B according to embodiments of the present invention.

FIG. 5A is a perspective view of an alternative protection device that may be used in the electrical connection assembly of FIG. 1 according to embodiments of the present invention.

FIG. 5B is a sectional view of the protection device of FIG. 5A.

FIG. 5C is an exploded side view of the protection device of FIG. 5A.

FIG. 6 is a perspective view of a main housing body of the protection device of FIG. 5A.

FIGS. 7A-7B are perspective end views of a securing member of the protection device of FIG. 5A.

FIG. 8A is a perspective view of a pinch ring of the protection device of FIG. 5A according to embodiments of the present invention.

FIG. 8B is an end view of the pinch ring of FIG. 8A.

FIGS. 9A-9B are perspective end views of a grommet of the protection device of FIG. 5A according to embodiments of the present invention.

FIG. 10 is an enlarged perspective view of an electrical connection assembly utilizing the protection device of FIG. 5A according to embodiments of the present invention.

FIG. 11 is a perspective view of an alternative configuration for the protection device of FIG. 5A according to embodiments of the present invention.

FIG. 12A is a perspective view of a first housing member of the protection device of FIG. 11 according to embodiments of the present invention.

FIG. 12B is a side view of the first housing member of FIG. 12A.

FIG. 13A is a perspective view of a second housing member of the protection device of FIG. 11 according to embodiments of the present invention.

FIG. 13B is a side view of the second housing member of FIG. 13A.

FIG. 14A is a perspective view of an electrical connection assembly utilizing the protection device of FIG. 11 according to embodiments of the present invention.

FIG. 14B is a sectional perspective view of the electrical connection assembly of FIG. 14A according to embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

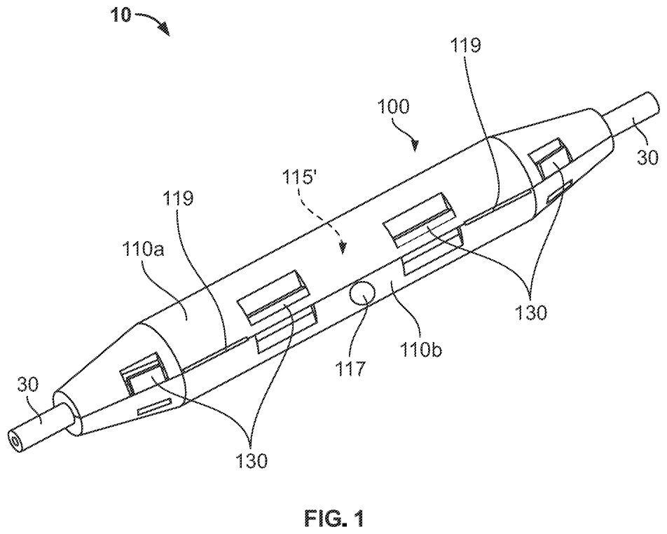

Embodiments of the invention are directed to protection devices and electrical connection assemblies utilizing the protection devices that protect and provide an effective scal from environmental conditions (e.g., moisture, UV exposure), fire retardancy and/or impact resistance which could potentially damage the electrical component contained therein. The protection devices of the present invention reduce material usage and eliminate the need for a complex assembly/molding process, thereby simplifying the manufacturing process while also reducing manufacturing costs. Embodiments of the present invention will now be discussed in greater detail below with reference to FIGS. 1-14B.

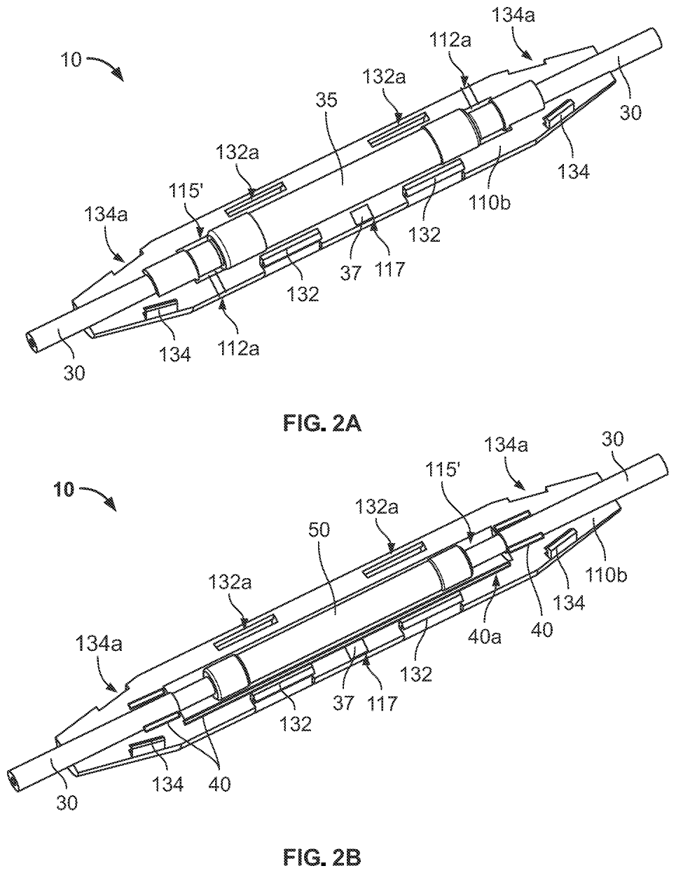

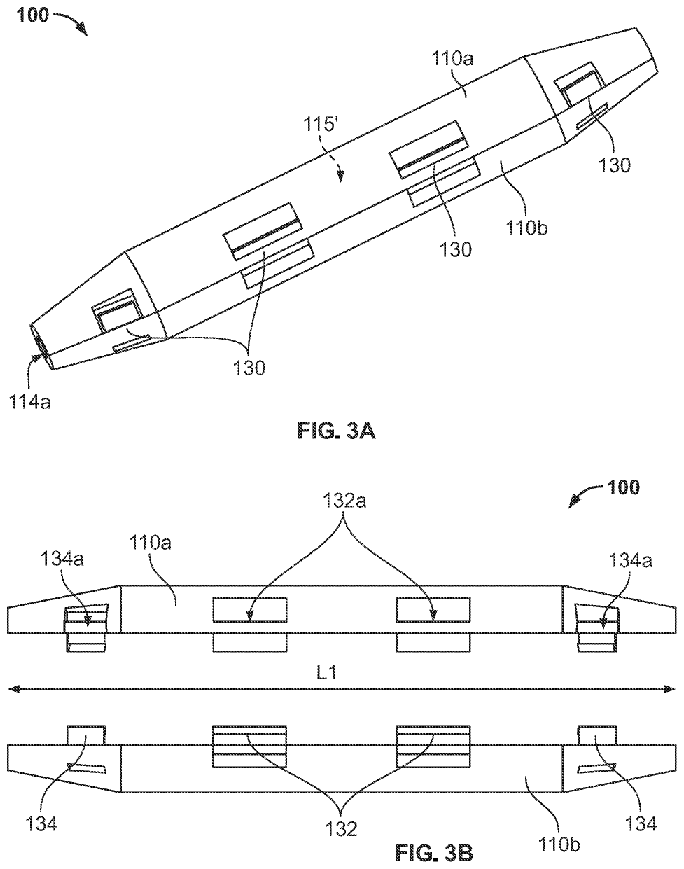

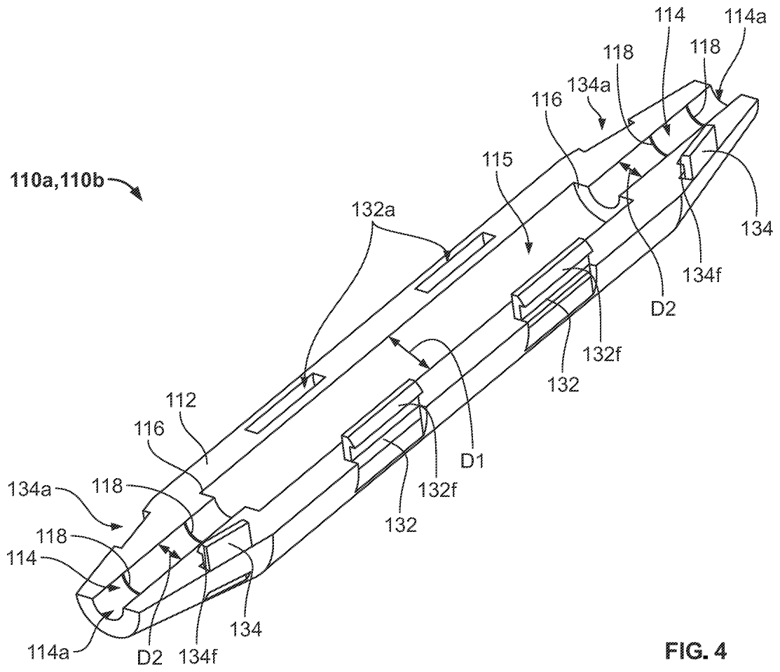

An electrical connection assembly according to some embodiments of the present invention, designated broadly at 10, is illustrated in FIGS. 1-2B. As shown in FIGS. 1-2B, the electrical connection assembly 10 includes a protection device 100 that is configured to protect an in-line electrical component 50 between two cables 30 (see also, e.g., FIGS. 3A-3B and FIG. 4). In some embodiments, the electrical component 50 may be a fuse, sensor, or connector. In some embodiments, the electrical component 50 may be a photovoltaic fuse. The protection device 100 is sized and configured to surround the electrical component 50 and provide a seal with the cables 30 connected to and extending outwardly from opposing ends of the electrical component 50. In some embodiments, the protection device 100 helps to provide protection from environmental conditions (e.g., moisture, UV exposure), dirt/dust ingress, fire retardancy, impact resistance, and/or general mechanical protection (e.g., crush or other force applied that is not an impact) which could potentially damage the electrical component 50 contained therein.

As shown in FIG. 1 and FIGS. 2A-2B, and discussed in further detail below, in some embodiments, the protection device 100 includes an internal cavity 115′ (formed by aligned main channels 115 of housing members 110a, 110b) that is sized and configured to hold the electrical component 50 therein (FIG. 2B). As shown in FIG. 2A, in some embodiments, the internal cavity 115′ (main channels 115) of the protection device 100 may be sized and configured to hold the electrical component 50 having a layer of heat shrink 35 applied around the electrical component 50.

Referring to FIGS. 3A-3B and FIG. 4, the protection device 100 according to embodiments of the present invention is illustrated. As shown in FIGS. 3A-3B, in some embodiments, the protection device 100 may comprise one or more housing members 110 that are configured to be secured together around the electrical component 50. In some embodiments, the one or more housing members 110 may be formed from one or more polymeric and/or elastomeric materials. For example, in some embodiments, the one or more housing members 110 may be formed from multiple layers of polymeric and/or elastomeric materials. Materials that may form the protection device 100 include, but are not limited to, polyamide, polyphenylene ether, polypropylene, polystyrene, or any other suitable polymeric or elastomeric material that meets the required properties for the desired use (e.g., F1 rating for outdoor industrial use, flame retardancy, impact resistance, etc.).

As shown in FIG. 3B, in some embodiments, the protection device 100 may comprise two housing members 110a, 110b that are configured to be secured together via one or more locking mechanisms 132, 134. In some embodiments, the two housing members 110a, 110b may be identical which allows the housing members 110a, 110b to be formed from the same mold, thereby simplifying the manufacturing process while also reducing manufacturing costs. As shown in FIG. 3B, in some embodiments, the housing members 110a, 110b may be two separate components that are configured to be snapped (secured) together via the locking mechanisms 132, 134. In some embodiments, the housing members 110a, 110b may be coupled together via one or more living hinges 119 (see, e.g., FIG. 1) which allows the housing members 110a, 110b to pivot between an opened position and a closed position, e.g., around the electrical component 50. Each housing member 110a, 110b has a sufficient length L1 to extend past the electrical component 50 to be protected and engage the cables 30 connected at opposing ends to the electrical component 50 (see, e.g., FIGS. 2A-2B). For example, in some embodiments, the length L1 of the housing members 110a, 110b (i.e., the length L1 of the protection device 100) is in a range of between about 100 mm and about 300 mm.

As shown in FIG. 4, in some embodiments, each housing member 110a, 110b has a main body 112 with a series of channels 114, 115 that together extend longitudinally the length L1 of the main body 112 of each housing member 110a, 110b. As noted above, in some embodiments, each housing member 110a, 110b has a main channel 115 having a first inner diameter D1. For example, in some embodiments, the main channel 115 of each housing member 110a, 110b has an inner diameter D1 in a range of between about 10 mm and about 100 mm. As noted above, together the main channels 115 of the housing members 110a, 110b form an internal cavity 115′ that is sized and configured to fit the electrical component 50 to be protected therein (and, in some embodiments, an electrical component 50 having a heat shrink layer 35) (see also, e.g., FIGS. 2A-2B). In other words, when the housing members 110a, 110b of the protection device 100 are secured together, the electrical component 50 (and, optionally, the heat shrink layer 35) fits within the aligned main channels 115 of the mated housing members 110a, 110b (i.e., the internal cavity 115′ of the protection device 100) (see, e.g., FIGS. 2A-2B).

As further shown in FIG. 4, in some embodiments, each housing member 110a, 110b of the protection device 100 also have first and second cable channels 114 that are in fluid communication with and extend axially outwardly in opposing directions from the main channel 115 (i.e., the main channel 115 resides between the first and second cable channels 114). The first and second cable channels 114 have a second inner diameter D2 that is sized and configured such that a respective cable 30 fits therein (see also, e.g., FIGS. 2A-2B). In other words, when the housing members 110a, 110b of the protection device 100 are secured together, the respective cables 30 (i.e., connected to and extending outwardly from opposing ends of the electrical component 50) fit within the aligned first and second cable channels 114 of the mated housing members 110a, 110b (see, e.g., FIGS. 2A-2B). For example, in some embodiments, the first and second cable channels 114 have an inner diameter D2 in a range of between about 3 mm and about 50 mm. As shown in FIG. 4, in some embodiments, the inner diameter D2 of the first and second cable channels 114 is equal to or less than the inner diameter D1 of the main channel 115 (i.e., D2≤D1) which may form respective shoulders 116 between the main channel 115 and the first and second cable channels 114.

The first and second cable channels 114 extend to openings 114a at opposing ends of the main body 112 of the housing members 110a, 110b. The openings 114a provide entry points into the protection device 100 for the cables 30. As shown in FIG. 4, in some embodiments, the first and/or second cable channels 114 may comprise one or more rib members 118. In some embodiments, the one or more rib members 118 may help provide an additional seal between the protection device 100 and the cables 30, for example, when a smaller diameter cable 30 is inserted into the respective channel 114. In addition, the one or more rib members 118 may help provide additional grip on the cables 30 to further secure the cables 30 within the respective channel 114.

Still referring to FIG. 4 (see also, e.g., FIGS. 2A-2B and FIG. 3B), as discussed above, in some embodiments, each housing member 110a, 110b may further include one or more locking mechanisms 132, 134. In some embodiments, the locking mechanism 132, 134 extend upwardly from the main body 112 of each housing member 110a, 110b and may reside proximate to an outer edge of the main body 112. Each housing member 110a, 110b also includes one or more corresponding apertures 132a and recesses 134a that are configured to receive/engage with the locking mechanism 132, 134 of the other housing member 110a, 110b (i.e., to secure the two members 110a, 110b together). In some embodiments, the apertures 132a and recesses 134a may reside proximate to an opposing outer edge of the main body 112 from the locking members 132, 134. In some embodiments, the locking mechanisms 132, 134 of one member 110a are positioned and configured to align with and be received by a corresponding aperture 132a or recess 134a of the other member 110b to secure the two members 110a, 110b together. In some embodiments, the locking mechanisms 132, 134 are configured to provide a snap-fit type connection with the corresponding aperture 132a or recess 134a. For example, in some embodiments, each locking mechanism 132, 134 may comprise a cantilevered latch or hook 132f, 134f that is configured to deflect and engage with the respective aperture 132a or recess 134a when the two housing members 110a, 110b are pressed (snapped) together, thereby securing the housing members 110a, 110b together.

In some embodiments, one of the housing members 110a, 110b may comprise an additional aperture or recess 117 that is configured to receive a sensor 37 therein (see, e.g., FIG. 1 and FIGS. 2A-2B). In some embodiments, the sensor 37 may be used for the detection of a blown fuse, high temperature event, and/or provide other critical information with respect to, for example, the electrical component 50 contained within the protection device 100. In some embodiments, pockets or channels 40a of mastic (or other sealing) material 40 may be incorporated into the protection device 100 (e.g., between the two housing members 110a, 110b) in order to further seal the electrical component 50 from the outside environment, as well as help improve the secureness of the cables 30 in the protection device 100 (see, e.g., FIG. 2B). As shown in FIG. 2A, in some embodiments, for example, if mastic (or other sealing) material 40 is not used (other than a heat shrink layer 35), the main body 112 of one or both of the housing members 110a, 110b may further comprise one or more drain holes 112a to help prevent the accumulation of water inside the internal cavity 115′ of the protection device 100.

To install the protection device 100, the electrical component 50 is first placed within the main channel 115 of one of the housing members 110b and the cables 30 extending from opposing ends of the electrical component 50 are placed in respective cable channels 114. Optionally, mastic 40 (or other like sealing material) may be placed in pockets and/or channels 40a along one or both of the housing members 110a, 110b and/or on each side of the cables 30 adjacent to where the cables 30 enter the main channel 115 (i.e., near shoulders 116). The other housing member 110a is then placed over the housing member 110b holding the electrical component 50 and cables 30 therein and the respective locking mechanisms 132, 134 are aligned with the corresponding apertures 132a and recesses 134a for both housing members 110a, 110b. Once aligned, the two housing members 110a, 110b are pressed together to engage the locking mechanisms 132, 134 with the corresponding apertures 132a and recesses 134a to mate the two housing members 110a, 110b together, thereby securing the electrical component 50 (and ends of the cables 30 connected thereto) within the protection device 100.

For installation of the protection device 100 having the housing members 110a, 110b coupled together via a living hinge 119, after the electrical component 50 and cables 30 are placed in the channels 114, 115 of one of the housing members 110b, the other housing member 110a may be pivoted to a closed position and secured to the housing member 110b holding the electrical component 50 and cables 30 in a similar manner as described above.

In other embodiments, the protection device 100 may comprise multiple additional housing members 110 with some of the housing members 110 including features that are configured to mechanically secure the cable 30 to each end of the electrical component 50 to provide additional strain relief. In some embodiments, the additional strain relief provided by these features may help allow the electrical connection assembly 10 satisfy the requirements of Underwriters Laboratories (UL) Standard UL9703 for Distributed Generation Wiring Harnesses.

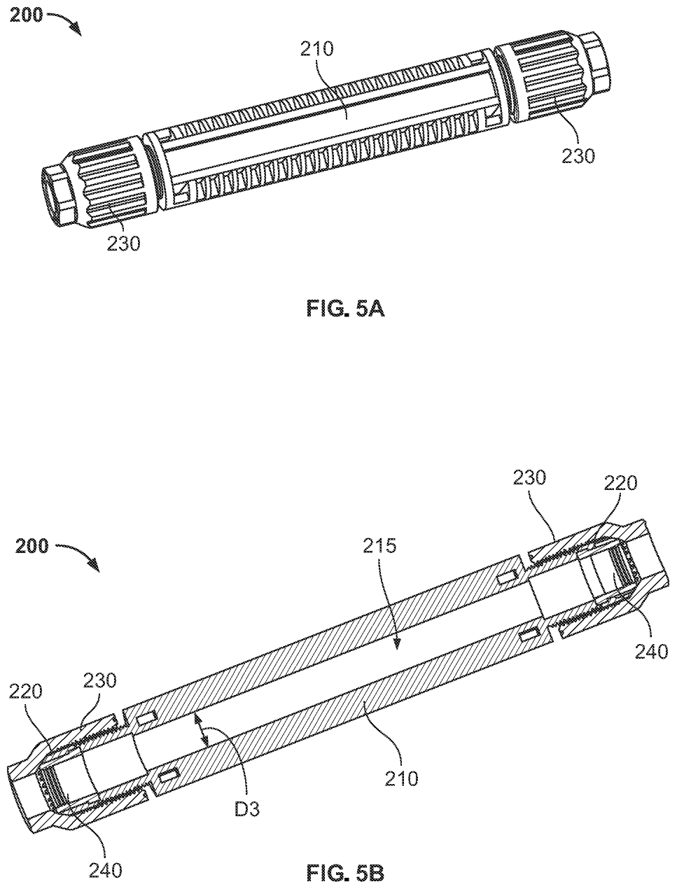

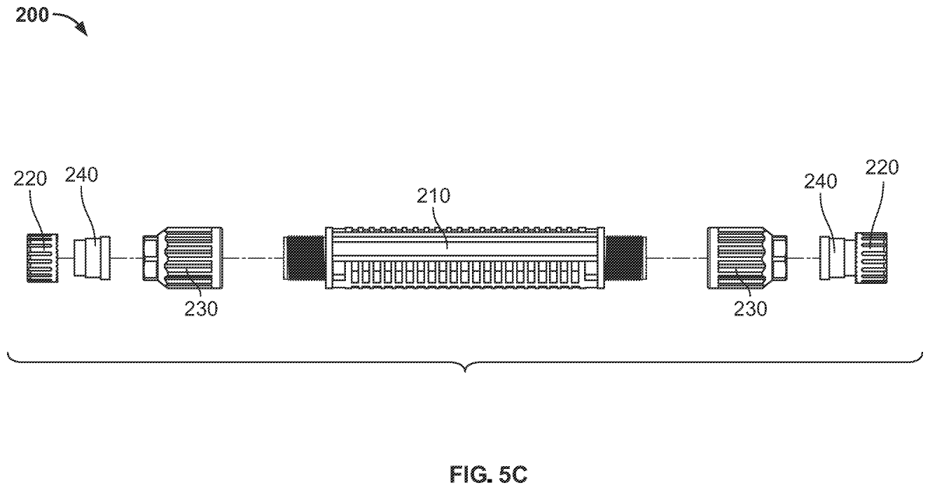

Referring now to FIGS. 5A-10, an alternative protection device 200 for an electrical connection assembly 10′ according to embodiments of the present invention is illustrated. Properties and/or features of the protection device 200 and/or electrical connection assembly 10′ may be as described above in reference to the protection device 100 and electrical connection assembly 10 shown in FIGS. 1-4 and duplicate discussion thereof may be omitted herein for the purposes of discussing FIGS. 5A-10.

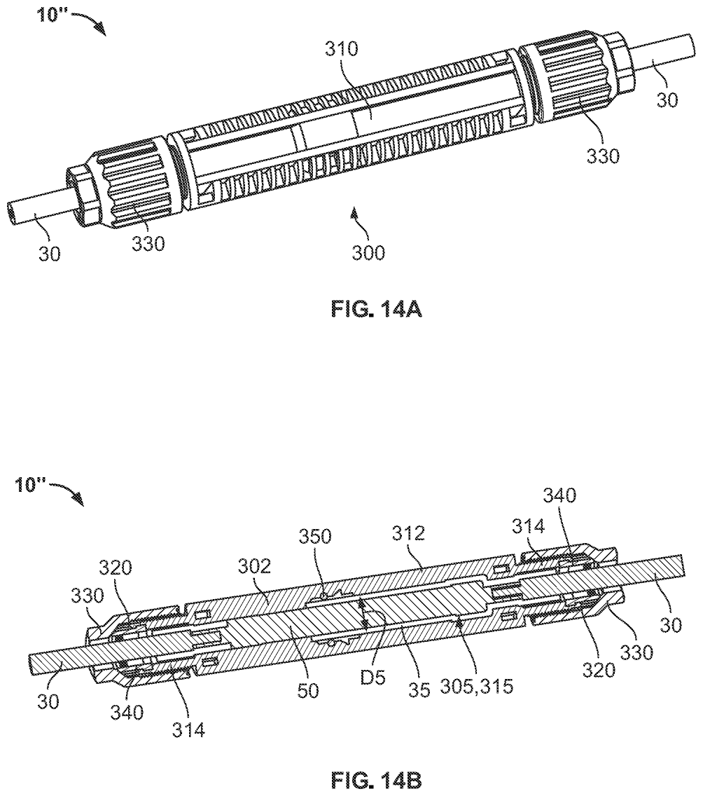

The protection device 200 that is configured to protect an in-line electrical component 50 between two cables 30 in a similar manner to the protection device 100 shown in FIGS. 3A-3B and FIG. 4 (see also, e.g., FIGS. 14A-14B). The protection device 200 is sized and configured to surround the electrical component 50 and provide a seal with the cables 30 connected to and extending outwardly from opposing ends of the electrical component 50. In some embodiments, the protection device 200 helps provide protection from environmental conditions (e.g., moisture, UV exposure), dirt/dust ingress, fire retardancy, impact resistance and/or general mechanical protection which could potentially damage the electrical component 50 contained therein. In some embodiments, the electrical component 50 may be a fuse, sensor, or connector. In some embodiments, the electrical component 50 may be a photovoltaic fusc.

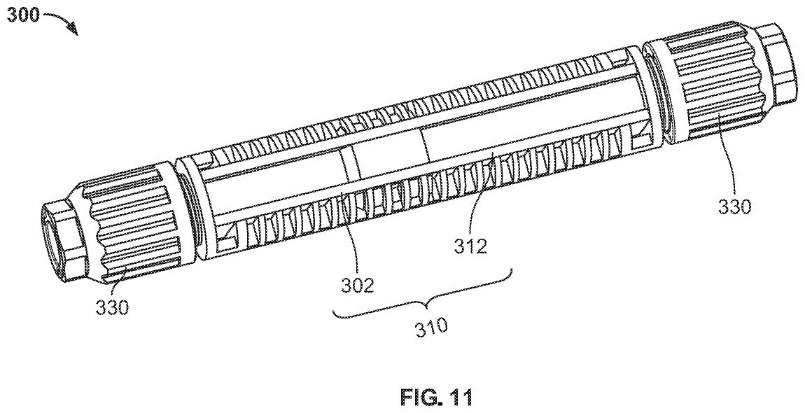

As shown in FIGS. 5A-5C, the protection device 200 includes a tubular housing 210. Two securing members 230 that are configured to engage opposing ends of the housing 210 to secure the protection device 200 around the electrical component 50 and to the cables 30 connected thereto. In some embodiments, the housing 210 may comprise two or more housing members that are secured together, for example, when a larger electrical component 50 needs to be protected (see, e.g., protection device 300 illustrated in FIGS. 11-14B and described in further detail below). As further shown in FIGS. 5A-5C, the protection device 200 also includes two pinch rings 220. Each pinch ring 220 may be integral with or coupled to opposing ends of the housing 210. In addition, the protection device 200 may further comprise two grommets 240. The grommets 240 are sized to fit within an inner diameter of a respective pinch ring 220 and configured to engage the cables 30. As discussed in further detail below, the pinch rings 220 and grommets 240 help provide a seal between the protection device 200 and the cables 30. Similar to the protection device 100 described herein, the protection device 200 may be formed from a polymeric and/or elastomeric material. Materials that may form the protection device 200 include, but are not limited to, polyamide, polyphenylene ether, polypropylene, polystyrene, or any other suitable polymeric or elastomeric material that meets the required properties for the desired use (e.g., F1 rating for outdoor industrial use, flame retardancy, impact resistance, etc.).

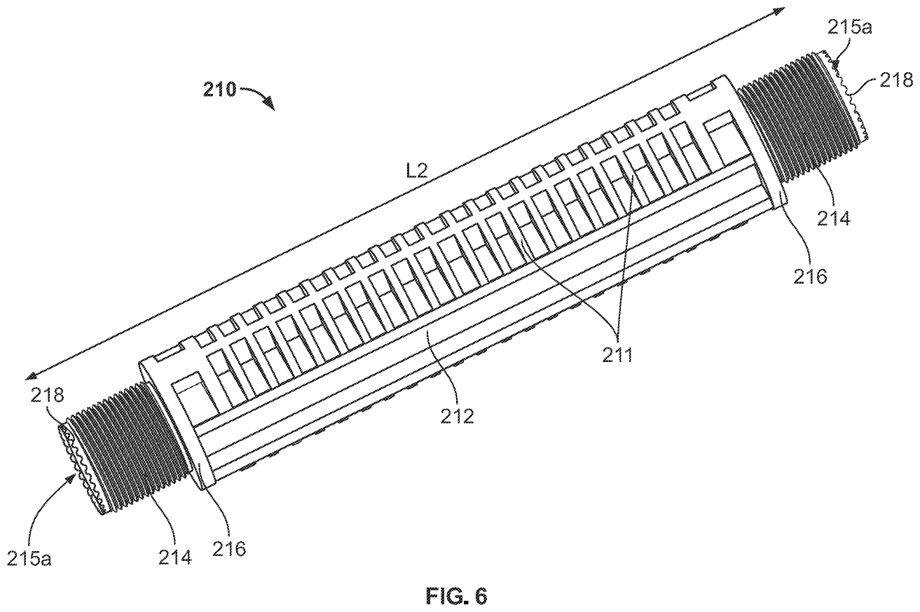

The housing 210 of the protection device 100 is further illustrated in FIG. 6. As shown in FIGS. 5A-5C and FIG. 6, in some embodiments, the housing 210 has a main body 212 that may have a cylindrical shape. In other embodiments, the main body 212 of the housing 210 may have another shape (e.g., hexagonal). The housing 210 has a length L2 in a range of between about 100 mm and about 300 mm. The housing 210 comprises threaded sections 214 at opposing ends of the main body 212 and a bore 215 extending therethrough (see, e.g., FIG. 5B). Openings 215a reside at opposing ends of the housing 210, thereby providing entry/exit points for the cables 30. As described in further detail below, the threaded sections 214 are configured to engage with the securing members 230 to secure the protection device 100 to the cables 30 and around the electrical component 50. The bore 215 has an inner diameter D3 sized and configured to fit around the electrical component 50 (and, in some embodiments, an electrical component 50 having a heat shrink layer 35 such as shown in FIG. 2A). For example, in some embodiments, the bore 215 of the housing 210 has an inner diameter D3 in a range of between about 10 mm and about 100 mm.

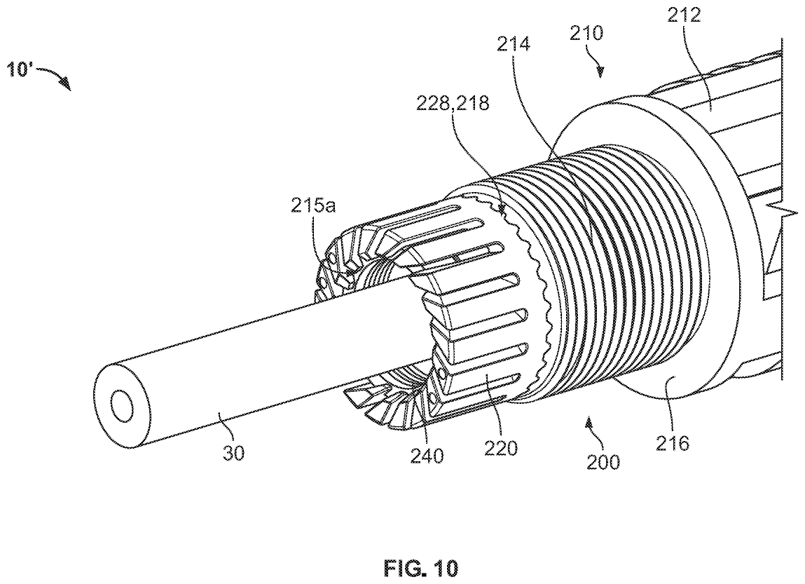

As shown in FIG. 6, in some embodiments, a plurality of engagement (anti-rotation) features 218 are located at the free ends of the threaded sections 214 (i.e., proximate to the openings 215a of the housing 210). As discussed in further detail below, in some embodiments, as shown in FIG. 10, the plurality of engagement features 218 are configured to engage with corresponding features 228 of the pinch rings 220 (i.e., when the pinch rings 220 are separate components and not integrally formed with the housing 210). In some embodiments, the main body 212 of the housing 210 may comprise a plurality of gripping features 211. The gripping features 211 may be configured to help a user hold onto the housing 210, for example, when the housing 210 is being slid onto a cable 30 and around the electrical component 50 to be protected. In some embodiments, as shown in FIG. 6, the outer diameter of the main body 212 of the housing 210 may be greater than the outer diameter of the threaded sections 214 such that an annular shoulder 216 is formed between the main body 212 and the threaded sections 214. In some embodiments, the annular shoulders 216 may serve as a mechanical stop for the securing members 230.

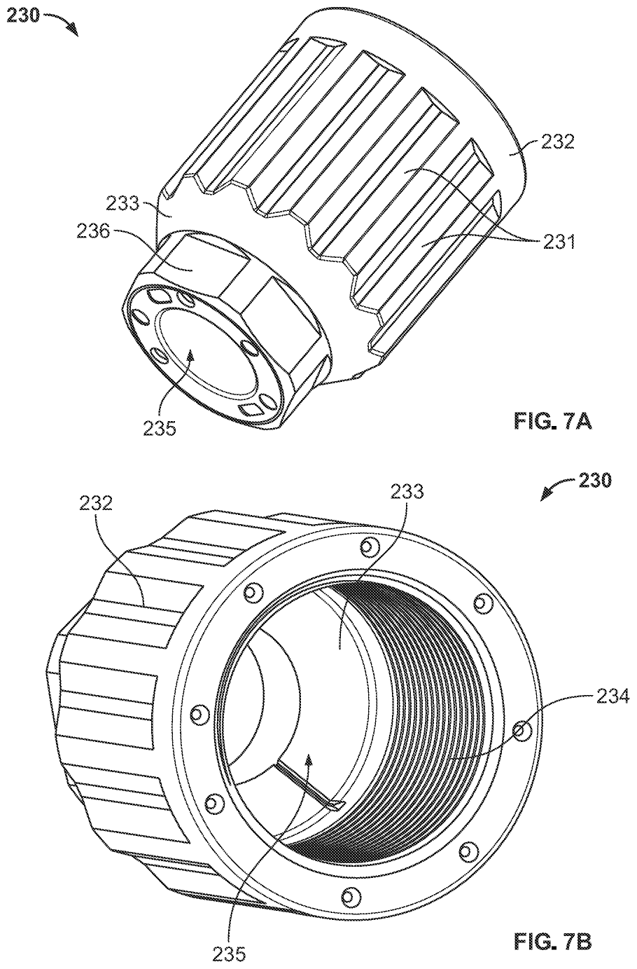

Referring to FIGS. 7A-7B, one of the securing members 230 of the protection device 200 according to embodiments of the present invention is illustrated. As shown in FIGS. 7A-7B, each securing member 230 has a main body 232 with a bore 235 extending therethrough. The main body 232 of the securing members 230 are sized and configured to engage the threaded sections 214 of the housing 210. In some embodiments, the main body 232 may comprise a tapered section 233. For example, in some embodiments, at least a portion of an inner surface of the main body 232 of each securing member 230 has a threaded section 234. The threaded section 234 of the securing member 230 is configured to engage a respective threaded section 214 of the housing 210 to secure the securing member 230 to the housing 210. As discussed in further detail below, in some embodiments, the tapered section 233 of the securing member 230 is configured to engage with the pinch ring 220 to help create a seal between the grommet 240 and the cable 30.

In some embodiments, the main body 232 of the securing member 230 may further comprise a plurality of gripping features 231 to help a user handle the securing member 230 when screwing the securing member 230 onto the housing 210. In some embodiments, the main body 232 of each securing member 230 may further comprise an end segment 236 configured such that a tool (e.g., a hex wrench) may be used to help tighten the securing members 230 onto the housing 210.

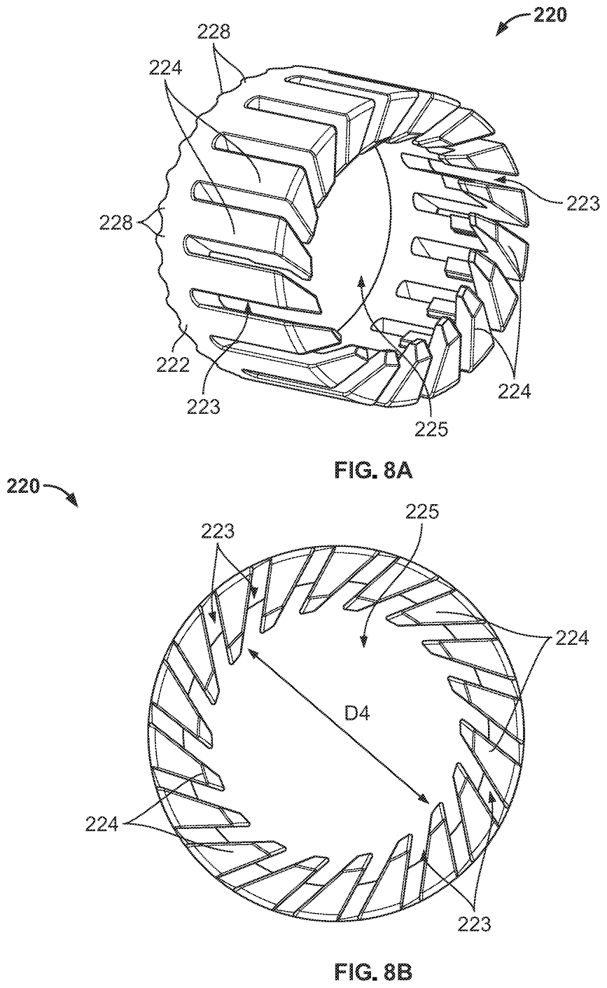

Referring to FIGS. 8A-8B, one of the pinch rings 220 of the protection device 200 according to embodiments of the present invention is illustrated. As shown in FIGS. 8A-8B, each pinch ring 220 has an annular main body 222 with an opening 235 extending therethrough having an inner diameter D4. The inner diameter D4 that is sized and configured to receive a grommet 240 (and a cable 30) (see, e.g., FIG. 10). For example, in some embodiments, the opening 235 of the pinch ring 220 has an inner diameter D4 in a range of between about 3 mm and about 50 mm. As noted above, in some embodiments, the main body 222 may comprise a plurality of engagement (anti-rotation) features 228 that are configured to engage with corresponding features 218 of the threaded sections 214 of the housing 210 (see, e.g., FIG. 10). As further shown in FIGS. 8A-8B, the pinch rings 220 further comprises a plurality of fingers 224 extending radially inwardly at an angle from the main body 222. A gap 223 resides between each of the fingers 224. As discussed in further detail below, as the securing member 230 is being tightened onto the threaded section 214 of the housing 210, the tapered section 233 of the securing member 230 forces the fingers 224 to deflect and exert a radially inward force against the grommet 240 and subsequently the cable 30, thereby creating a seal between the protection device 200 and the cable 30.

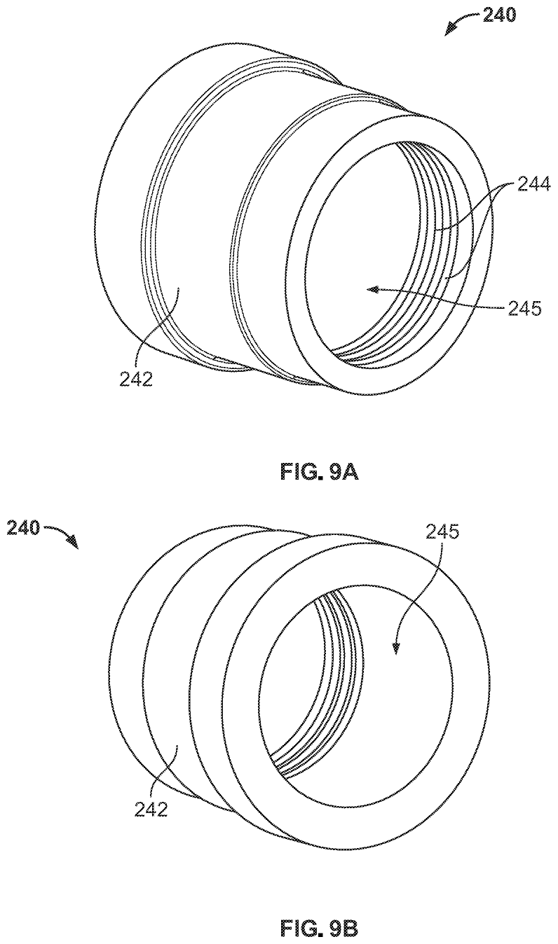

Referring to FIGS. 9A-9B, one of the grommets 240 of the protection device 200 according to embodiments of the present invention is illustrated. Each grommet 240 has an annular main body 242 with an opening 245 extending therethrough. As noted above, the grommet 240 are sized to fit within the inner diameter D4 of the pinch rings 220. The opening 245 is sized and configured to receive a cable 30 connected to and extending outwardly from the electrical component 50 (see, e.g., FIG. 10). In some embodiments, an inner surface of the grommets 240 may comprise one or more annular ribs 244. Similar to the rib members 118 described herein with respect to protection device 100, in some embodiments, the one or more annular rib 244 of the grommet 240 may help provide an additional seal between the protection device 200 and the cables 30, for example, when a smaller diameter cable 30 is inserted through the opening 245 of the grommet 240. In addition, the one or more annular ribs 244 may help provide additional grip on the cables 30 to further secure the cables 30 within the grommet 240. As discussed further below, in some embodiments, the interaction between the grommet 240 and pinch ring 220 provide an effective seal from the outside environment such that a heat shrink layer 35 covering the electrical component 50 may not be needed. In other embodiments, a head shrink layer 35 may still be applied to the electrical component 50 and the bore 215 of the housing 210 may be filled with mastic (or other like sealing) material 40 to remove any air spaces within the bore 215.

An electrical connection assembly 10′ according to embodiments of the present invention and utilizing the protection device 200 described herein is illustrated in FIG. 10. FIG. 10 shows one end of the protection device 200 without the securing member 230 threaded onto the threaded section 214 of the housing 210. A cable 30 is extending out through the opening 215a of the housing 210. As shown in FIG. 10, the grommet 240 is sized and configured to fit within the pinch ring 220. The engagement (or anti-rotation) features 218, 228 of the threaded section 214 of the housing 210 and the pinch ring 220 are configured to engage with each other. For example, as shown in FIG. 10, in some embodiments, the engagement features 218, 228 may comprise a plurality of recesses or protrusions that are configured to interlock with each other. The interlocking of the engagement features 218, 228 may help to provide additional resistance from the pinch ring 220 rotating relative to the housing 210 after the securing member 230 is tightened on the threaded section 214 of the housing 210. In other embodiments, the pinch ring 220 may be integrally formed with the housing 210, and thus, the engagement features 218, 228 would not be needed.

To install the protection device 200, first, the securing members 230, pinch rings 220, grommets 240, and housing 210 are slid over an electrical connection until the electrical component 50 to be protected is fully received within the bore 215 of the housing 210 and the cables 30 connected thereto extend outwardly from opposing ends of the housing 210. When the pinch rings 220 are separate components (i.e., not integrally formed with the housing), a user secures the grommets 240 within the respective pinch rings 220, and the anti-rotation features 228 of the pinch rings 220 are engaged with corresponding anti-rotation features 218 of the housing 210. After the pinch rings 220 and grommets 240 are in position, each securing member 230 may then be screwed onto respective threaded sections 214 of the housing 210, either by hand and/or with a tool. As the securing members 230 are tightened onto the threaded sections 214 of the housing 210, a radially inward force is applied by the tapered section 233 of the securing member 230 against the plurality of fingers 224 of the pinch ring 220. The radially inward force causes the fingers 224 of the pinch ring 220 to deflect against the grommet 240, thereby securing the grommet 240 in place, while also creating an effective seal against the cable 30.

Referring to FIGS. 11-13B, an alternative protection device 300 according to embodiments of the present invention is illustrated. An electrical connection assembly 10″ according to embodiments of the present invention and utilizing the protection device 300 described herein is illustrated in FIGS. 14A-14B. Properties and/or features of the protection device 300 and electrical connection assembly 10″ may be as described above in reference to the protection device 200 and electrical connection assembly 10′ shown in FIGS. 5A-10 and duplicate discussion thereof may be omitted herein for the purposes of discussing FIGS. 11-14B.

As shown in FIG. 11, the protection device 300 differs from the protection device 200 described herein in that the housing 310 of the protection device 300 comprises two housing members 302, 312 that are configured to be secured together, thereby allowing the protection device 300 of the present invention to be used with respect to larger clectrical components 50 that would not typically fit within the single housing 210 configuration of the protection device 200. The remaining components of the protection device 300 (i.e., pinch rings 320, securing members 330, and grommets 340) are similar to those described herein with respect to protection device 200, and therefore, will not be described in further detail (see, e.g., FIG. 14B). It is noted that in other embodiments, the protection device of the present invention may include more than two housing members secured together in a similar manner as described below.

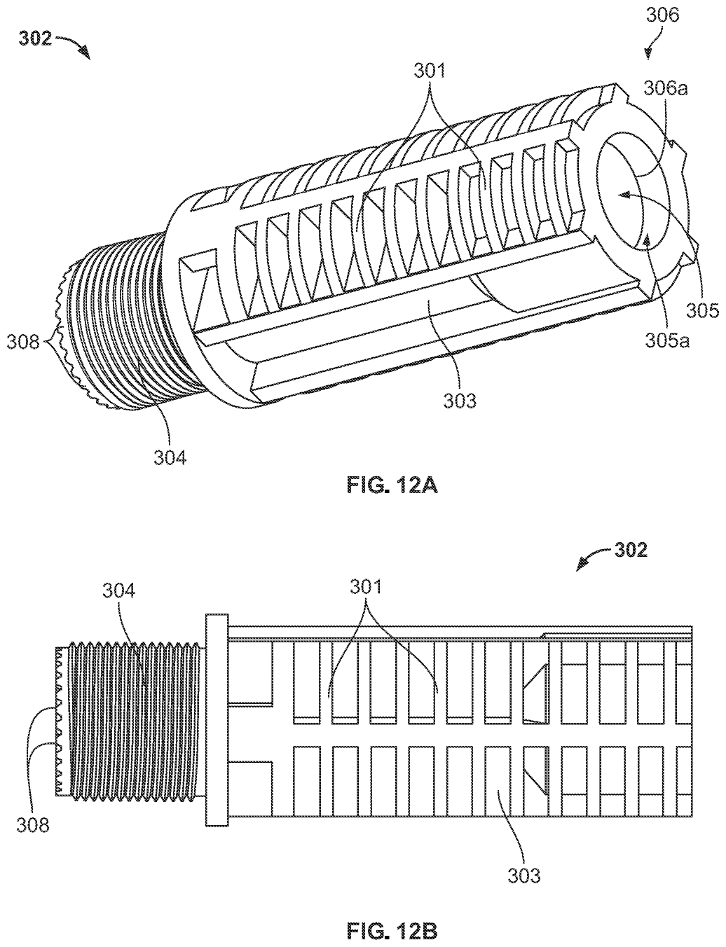

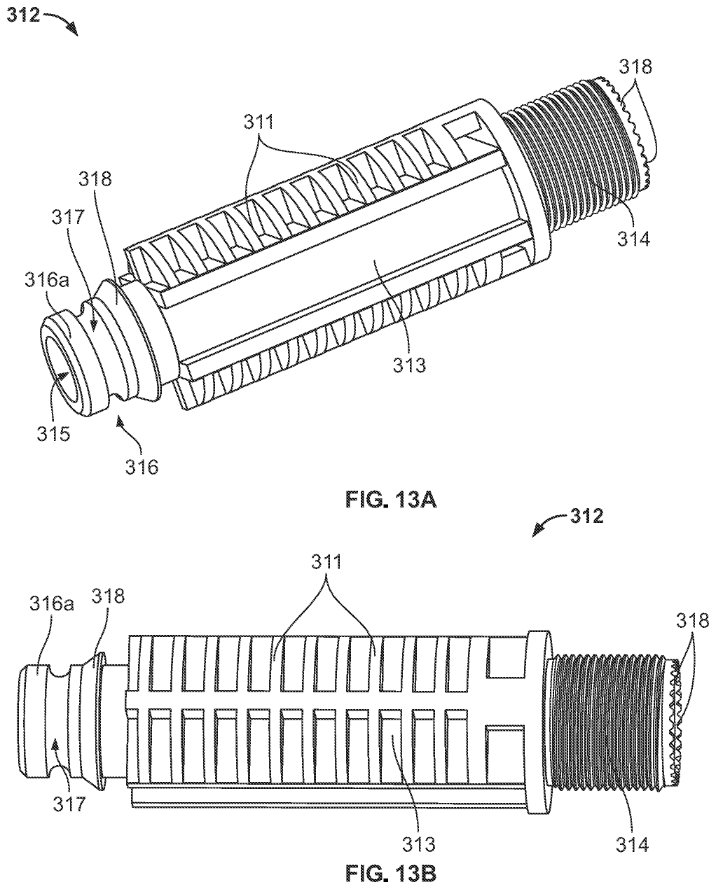

Referring to FIGS. 12A-12B and FIGS. 13A-13B, the housing members 302, 312 of the housing 310 are illustrated. Similar to the housing 210 of the protection device 200, both housing members 302, 312 of the protection device 300 have tubular main bodies 303, 313. In some embodiments, the housing 310 has a cylindrical shape. Each of the housing members 302, 312 comprise a threaded section 304, 314 at one end of the main body 303, 313 and a securing mechanism 306, 316 at the opposing end of the main body 303, 313. As discussed in further detail below, the securing mechanisms 306, 316 are configured to engage with each other to secure the two housing members 302, 312 together to form the housing 310 of the protection device 300.

A bore 305, 315 extends through each housing member 302, 312 (see, e.g., FIG. 5B). Similar to the protection device 200 described herein, each threaded section 304, 314 is configured to engage a respective securing member 330 to secure the protection device 300 to the cables 30 connected to an electrical component 50. The bores 305, 315 have an inner diameter D5 sized and configured to fit around an electrical component 50 (and, in some embodiments, an electrical component 50 having a heat shrink layer 35 such as shown in FIG. 14B). For example, in some embodiments, the bores 305, 315 of the housing members 302, 312 (i.e., housing 310) have an inner diameter D5 in a range of between about 10 mm and about 100 mm.

As shown in FIGS. 12A-12B and FIGS. 13A-13B, in some embodiments, a plurality of engagement (anti-rotation) features 308, 318 may be located at the free ends of the threaded sections 304, 314. Similar to the protection device 200, the plurality of engagement features 308, 318 are configured to engage with corresponding features of the pinch rings 320 (see, e.g., FIG. 14B). In some embodiments, the main bodies 303, 313 may further comprise a plurality of gripping features 301, 311. The gripping features 301, 311 are configured to help a user hold onto the housing members 302, 312, for example, when the housing members 302, 312 are being secured together and/or when the housing 310 is being slid onto a cable 30 and around the electrical component 50 to be protected.

As shown in FIG. 12A and FIGS. 13A-13B, in some embodiments, the securing mechanisms 306, 316 may comprise snap-fit type securing features. For example, in some embodiments, one housing member 302 may comprise an annular lip 306a adjacent to an opening 305a of the bore 305 and the securing mechanism 316 for the other housing member 312 may comprise a flanged edge 316a and recess 317. In some embodiments, the recess 317 is configured to receive and hold an O-ring 350 therein to help provide a seal between the two housing members 302, 312 when secured together (see, e.g., FIG. 14B). In some embodiments, one of the housing members 312 may further comprise an annular sealing flange 318 which helps provide a further seal between the two housing members 302, 312 when secured together.

In some embodiments, to secure the housing members 302, 312 together, a user inserts the flanged edge 316a of one housing member 312 into the opening 305a of the other housing member 302 until the flanged edge 316a engages the annular lip 306a. In other embodiments, the flanged edge 316a may form an interference fit with an inner surface of the main body 303 of the housing member 302. Other types of snap-fit or securing mechanisms may be used to secure the housing members 302, 312 together. For example, in some embodiments, the securing mechanisms 306, 316 may form a cantilever snap joint. In other embodiments, the housing members 302, 312 may comprise threaded sections 304, 314 on both ends of the main bodies 303, 312 that allow the housing members 302, 312 to be screwed together.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

What is claimed is:

1. A protection device for an electrical connection including an electrical component and cables, the protection device comprising:
a first housing member having a main body having a length, the first housing member comprising a main channel, a first cable channel, and a second cable channel that together extend longitudinally the length of the main body; and
a substantially identical second housing member configured to be mated and secured to the first housing member via one or more locking mechanisms configured to be received by or engaged with one or more corresponding apertures and/or recesses,
wherein, when the first housing member and the second housing member are mated together, the aligned main channels of the first and second housing members form an internal cavity sized and configured to hold the electrical component therein and the aligned first and second cable channels are sized and configured to hold a respective cable connected to the electrical component therein.

2. The protection device according to claim 1, wherein the first and/or second cable channels of each housing member comprise one or more rib members.

3. The protection device according to claim 1, wherein the one or more locking mechanisms extend upwardly from the main body of each housing member and reside proximate to an outer edge of the main body, and wherein the one or more corresponding apertures and/or recesses reside proximate to an opposing outer edge of the main body of each housing member and are configured to receive and/or engage with a corresponding locking mechanism of the other housing member when mated together.

4. The protection device according to claim 1, wherein each locking mechanism comprises a cantilevered latch or hook that is configured to deflect and engage with the respective aperture or recess when the housing members are pressed together.

5. The protection device according to claim 1, wherein the first housing member and the second housing member are coupled together via a living hinge.

6. The protection device according to claim 1, wherein at least one of the housing members comprise one or more pockets or channels, the one or more pockets or channels configured to hold mastic or other sealing material therein.

7. The protection device according to claim 1, wherein the main body of at least one of the housing members further comprises one or more drain holes extending into the respective main channel.

8. The protection device according to claim 1, wherein at least one of the housing members comprises an additional aperture or recess that is configured to receive a sensor therein, the sensor being configured to collect information.

9. The protection device according to claim 1, wherein the device comprises a heat shrink layer applied to the electrical component.

10. The protection device according to claim 1, further comprising one or more additional housing members configured to mechanically secure the cables to each end of the electrical component.

11. An electrical connection assembly, the electrical connection assembly comprising:
an in-line electrical component having a pair of cables connected to and extending outwardly from opposing ends of the electrical component; and
a protection device surrounding the in-line electrical component and creating a seal with the pair of cables, wherein the protection device comprises:
a first housing member having a main body having a length, the first housing member comprising a main channel, a first cable channel, and a second cable channel that together extend longitudinally the length of the main body; and
an identical second housing member configured to be mated and secured to the first housing member via one or more locking mechanisms configured to be received by or engaged with one or more corresponding apertures and/or recesses,
wherein the first housing member and the second housing member are mated together such that the electrical component is held within the aligned main channels of the first and second housing members and each cable is respectively held within the aligned first and second cable channels.

12. The electrical connection assembly according to claim 11, wherein the main channel of each housing member resides between the first and second cable channels.

13. The electrical connection assembly according to claim 11, wherein the one or more locking mechanisms extend upwardly from the main body of each housing member and reside proximate to an outer edge of the main body, and wherein the one or more corresponding apertures and/or recesses reside proximate to an opposing outer edge of the main body of each housing member and are configured to receive and/or engage with a corresponding locking mechanism of the other housing member when mated together.

14. The electrical connection assembly according to claim 11, wherein at least one of the housing members comprise one or more pockets or channels, the one or more pockets or channels configured to hold mastic or other sealing material therein.

15. The electrical connection assembly according to claim 11, wherein the protection device comprises a heat shrink layer applied to the electrical component.

16. A protection device for an electrical connection including an electrical component and cables, the protection device comprising:
a tubular housing having a main body comprising threaded sections at opposing ends of the main body and a bore extending therethrough;
a pair of grommets, each grommet having an annular main body with an opening extending therethrough, the opening being sized and configured to receive a respective cable connected to the electrical component;
a pair of pinch rings, each pinch ring having an annular main body with an opening extending therethrough that is sized and configured to receive a respective grommet, wherein each pinch ring is integral with or coupled to a respective threaded sections of the housing; and
a pair of securing members, each securing member having a main body with at least a portion of an inner surface of the main body having a threaded section configured to engage a respective threaded section of the housing,
wherein the bore of the housing is sized and configured to hold the electrical component therein and the pinch rings and grommets are configured to create a seal between the protection device and the cables connected to the electrical component.

17. The protection device according to claim 16, wherein the housing comprises two or more housing members configured to be secured together.

18. The protection device according to claim 16, wherein the pinch rings and threaded sections of the housing comprise a plurality of engagement features configured to interlock with each other to prevent rotation of the pinch rings relative to the housing.

19. The protection device according to claim 16, wherein the main body of each securing member has a tapered section, wherein the tapered section is configured to engage with the pinch ring when the securing member is screwed onto the housing.

20. The protection device according to claim 16, wherein each pinch ring comprises a plurality of fingers extending radially inwardly at an angle from the main body and a gap residing between each of the plurality of fingers, the plurality of fingers being configured to deflect and exert a radially inward force against the grommet when the securing member is being tightened onto the threaded section of the housing.
